(19) United States
(12) Patent Application Publication
(10) Pub. No.: US 2026/0016090 A1
(43) Pub. Date: Jan. 15, 2026

(54) SEAL RING RETENTION AND CENTERING SYSTEM FOR A GYRATORY CRUSHER

(71) Applicant: Metso USA Inc., Brookfield, WI (US)

(72) Inventors: Matthew Potratz, Waukesha, WI (US); Robert Chartier, Waterford, WI (US); Timo Bischof, Münster (DE); Julian Weßeling, Münster (DE)

(73) Assignee: Metso USA Inc., Brookfield, WI (US)

(21) Appl. No.: 18/769,622

(22) Filed: Jul. 11, 2024

(51) Int. Cl. F16J 15/34; B02C 2/04

(52) U.S. Cl. CPC F16J 15/3472; B02C 2/04

(57) ABSTRACT

A gyratory crusher including a main shaft installed into a main frame. The gyratory crusher includes a seal ring assembly having a seal ring that engages a portion of the main frame to limit the movement of dust and particles during crushing operations. The seal ring assembly includes a plurality of seal ring retention assemblies that are each movable between an engaged centering position and a retracted operating position. In the centering position, each of the seal ring retention assemblies holds the seal ring in a centered position. When the seal ring is urged outward, the seal ring retention assemblies move away from the centering position to the retracted position. Each of the seal ring retention assemblies can be moved to the centering position from the exterior of the seal ring assembly to center the seal ring before installation of the main shaft into the frame of the crusher.

### BACKGROUND

The present disclosure generally relates to a system for aligning the main shaft of a gyratory crusher during assembly. More specifically, the present disclosure relates to a seal ring retention and centering system that holds the seal ring in a centered position during the installation of the main shaft into the lower frame of the crusher.

Cone crushers and gyratory crushers are two types of rock crushing systems which generally break apart rock, stone or other material in a crushing gap between a stationary element and a moving element. A cone or gyratory crusher is comprised of a head assembly including a crusher head that can include a replaceable mantle mounted to a main shaft that gyrates about a vertical axis within a stationary bowl attached to a main frame of the rock crusher. The crusher head is assembled surrounding an eccentric that rotates to impart the gyrational motion of the main shaft and crusher head, which crushes rock, stone or other material in a crushing gap between the crusher head and the stationary bowl. The eccentric can be driven by a variety of power drives, such as an attached gear, driven by a pinion and countershaft assembly, and a number of mechanical power sources, such as electrical motors or combustion engines.

The gyrational motion of the crusher head with respect to the stationary bowl crushes rock, stone or other material as it travels through the crushing gap. The crushed material exits the cone crusher through the bottom of the crushing gap.

A dust seal is typically provided between a dust collar, which carried by the stationary frame structure, and the movable crusher head to prevent the entrance of rock dust or the like into the operating mechanism of the crusher.

One problem associated with currently available gyratory crushers is the need for a person or persons to stand below the main shaft assembly as the main shaft assembly is lowered into the stationary main frame either during the initial assembly process or during maintenance that requires the main shaft assembly to be removed. Since the main shaft assembly can weigh thousands of pounds, there is apprehension among those assembling the gyratory crusher in standing beneath the main shaft assembly and manually aligning the main shaft and the associated dust seal relative to the stationary dust collar and bushing that receives the main shaft. Therefore, the present inventors have recognized the need to design a system that allows the main shaft assembly to be lowered into the stationary main frame without the need for a person or persons located below the main shaft assembly to properly align the main shaft, dust collar and dust seal.

### SUMMARY

The present disclosure relates to a system and method of aligning the main shaft of a gyratory crusher during assembly or after the main shaft has been removed for maintenance. More specifically, the present disclosure related to a retention system for maintaining the seal ring in a centered position during assembly and allowing the seal ring to be movable after assembly.

According to one exemplary embodiment of the present disclosure, a seal ring assembly is provided for use with the main shaft and crushing head of a gyratory crusher. The seal ring assembly is mountable to the main shaft. The seal ring assembly includes a retaining ring assembly that is configured to mount to the crushing head of the main shaft. The seal ring assembly of an exemplary embodiment includes an upper retaining ring and a lower retaining ring that are joined to each other and create a seal ring channel between the upper and lower retaining rings.

The seal ring assembly further includes a seal ring that is positioned within the seal ring channel and extends radially inward from the retaining ring assembly. During operation, the seal ring contacts a stationary portion of the main frame, such as a dust collar, to limit the movement of dust within the gyratory crusher. The seal ring is movable within the seal ring channel during operation of the gyratory crusher.

The seal ring assembly further includes a plurality of seal ring retention assemblies that are each positioned in the retaining ring assembly. The seal ring retention assemblies are each movable between an engaged centering position and a retracted operating position. The plurality of seal ring retention assemblies are equally spaced around the outer diameter of the seal ring such that the combination of the plurality of seal ring retention assemblies can act around the entire outer surface of the seal ring.

When the seal ring retention assemblies are in the engaged centering position, the seal ring retention assemblies contact an outer surface of the seal ring to move the seal ring to a centered position. The centered position of the seal ring is desired for installing the main shaft into the frame of the gyratory crusher since a centered seal ring will aid in aligning the main shaft with stationary portions of the main frame during installation. In one exemplary embodiment, a ball and detent are used to hold the seal ring retention assembly in the engaged centered position. Other bias elements are contemplated to hold the seal ring retention assemblies in the engaged centering position.

When the seal ring is urged radially outward, this outward movement releases the seal ring retention assemblies from the engaged centering position. The seal ring retention assembly will then move toward the retracted operation position in which the seal ring retention assembly is positioned out of contact with the seal ring, thereby allowing the seal ring to freely move in the seal ring channel.

In one embodiment of the present disclosure, each of the seal ring retention assemblies are rotatable between the engaged centering position and the retracted operating position. When the seal ring retention assembly is in the engaged centering position, a support roller contacts the outer surface of the seal ring to hold the seal ring in the centered position. When the seal ring is urged radially outward, the seal ring causes the support roller to rotate out of contact with the seal ring and be recessed away from contact with the seal ring.

In a second, alternate embodiment of the present disclosure, each of the seal ring retention assemblies are longitudinally movable into and out of contact with the seal ring during movement between the engaged centering position and the retracted operating position. When the seal ring retention assembly is in the engaged centering position, a barrel portion contacts the outer surface of the seal ring to hold the seal ring in the centered position. When the seal ring is urged radially outward, the seal ring causes the barrel portion to move out of contact with the seal ring and be recessed away from contact with the seal ring.

In accordance with the present disclosure, a gyratory crusher is provided that includes a main shaft and a seal ring assembly mounted to the main shaft. The seal ring assembly includes a retaining ring assembly that is configured to mount to the crushing head of the main shaft. The seal ring assembly of an exemplary embodiment includes an upper retaining ring and a lower retaining ring that are joined to each other and create a seal ring channel between the upper and lower retaining rings.

The seal ring assembly further includes a seal ring that is positioned within the seal ring channel and extends radially inward from the retaining ring assembly. During operation, the seal ring contacts a stationary portion of the main frame, such as a dust collar, to limit the movement of dust within the gyratory crusher. The seal ring is movable within the seal ring channel during operation of the gyratory crusher.

The seal ring assembly further includes a plurality of seal ring retention assemblies that are each positioned in the retaining ring assembly. The seal ring retention assemblies are each movable between an engaged centering position and a retracted operating position. The plurality of seal ring retention assemblies are preferably equally spaced around the outer diameter of the seal ring such that the combination of the plurality of seal ring retention assemblies can act around the entire outer surface of the seal ring.

When the seal ring is urged radially outward, this outward movement releases the seal ring retention assemblies from the engaged centering position. The seal ring retention assembly will then move toward the retracted operation position in which the seal ring retention assembly is positioned out of contact with the seal ring, thereby allowing the seal ring to freely move in the seal ring channel.

In one contemplated embodiment, a bias spring is used to hold the seal ring retention assemblies in the engaged centering position and another bias spring is used to bias the seal ring retention assembly into the retracted operating position. Each of the seal ring retention assemblies can be selectively moved to the engaged centering position to center the seal ring. Once in this position, the seal ring retention assembly is held until the seal ring urges the movement of the seal ring retention assembly back to the retracted, operating position.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a section view of a gyratory crusher of one exemplary embodiment of the present disclosure;

FIG. 2 is a perspective view of dust seal retainer of a first embodiment of the present disclosure;

FIG. 3 is a top perspective view of the seal ring and plurality of seal ring retention assemblies of the first embodiment of the present disclosure;

FIG. 4 is a side view of one of the seal ring retention assemblies of the first embodiment of the present disclosure;

FIG. 5 is an exploded view of the seal ring retention assembly of FIG. 4;

FIG. 6 is a section view of the seal ring retention assembly of the first embodiment in the retracted, operating position;

FIG. 7 is a section view of the seal ring retention assembly of the first embodiment in the engaged, centering position;

FIG. 8 is a section view of the seal ring and seal ring retention assembly of the first embodiment during installation of the main shaft;

FIG. 9 is a section view of the seal ring and seal ring retention assembly of the first embodiment showing the movement of the seal ring and seal ring retention assembly to the retracted, operation position;

FIG. 10 is a top view of a second embodiment of a seal retention assemblies in the engaged, centering position to center the seal ring;

FIG. 11 is a top view of the second embodiment of the seal retention assemblies in the retracted, operating position to allow movement of the seal ring;

FIG. 12 is a perspective view showing the installation of one of the seal retention assemblies of the second embodiment;

FIG. 13 is a perspective view of one of the seal retention assemblies in the engaged, centering position;

FIG. 14 is a perspective view of one of the seal retention assemblies in the retracted, operating position;

FIG. 15 is a section view of one of the seal retention assemblies of the second embodiment of the present disclosure;

FIG. 16 is an exploded view of one of the seal retention assemblies of the second embodiment of the present disclosure;

FIG. 17 is a section view of the seal ring and one of the seal retention assemblies of the second embodiment of the present disclosure in the engaged, centering position;

FIG. 18 is a section view of the seal ring and one of the seal retention assemblies of the second embodiment of the present disclosure in the retracted, operating position;

FIG. 19 is a bottom perspective view of the main shaft and crushing head;

FIG. 20 is a magnified view taken along line 20-20 of FIG. 19 showing one of the seal retention assemblies in the retracted, operating position; and

FIG. 21 is a magnified view similar to FIG. 20 showing one of the seal retention assemblies in the engaged, centering position.

### DETAILED DESCRIPTION

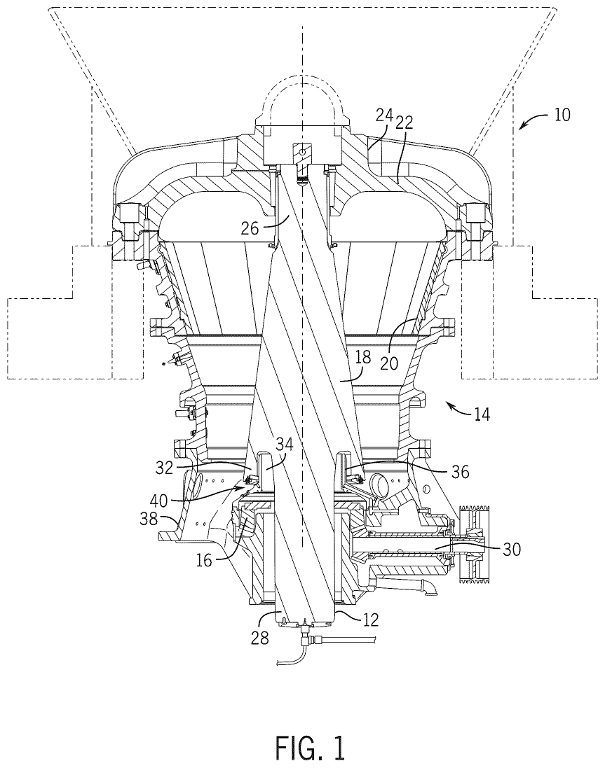

FIG. 1 illustrates a section view of a gyratory crusher 10 that is shown in an assembled, operative condition. The gyratory crusher 10 includes a main shaft 12 that is movably supported within a lower frame 14 of the crusher 10. The lower frame 14 is a stationary support that provides stability and support for an eccentric 16 that rotates and provides the gyratory motion to the main shaft 12. The main shaft 12 includes a crushing head 18 that supports a mantle that creates one of the two contact surfaces for crushing rocks and other material between the moving mantle and a stationary bowl 20. The main shaft 12 has a longitudinal axis that coincides with a central axis of the main frame 14. The main shaft 12 is suspended within a spider 22 having a center hub 24 that supports the top end 26 of the main shaft 12. The eccentric assembly 16 rotatably supports the bottom portion 28 of the main shaft 12 and is driven by a drive shaft 30 that imparts rotating and oscillating movement to the main shaft 12 through a gear assembly.

As illustrated in FIG. 1, the portion of the main shaft 12 that defines the crushing head 18 includes a mounting edge 32 that is spaced from the center, bottom portion 28 of the main shaft to define an annular channel 34 that receives a dust collar 36 designed to restrict the passage of dust and other debris from the crushing chamber defined within the gyratory crusher 10 into contact with the rotating and driving components of the gyratory crusher. The dust collar 36 is a stationary element that remains mounted to the bottom frame member 38 when the main shaft 12 is removed from the gyratory crusher for maintenance, such as replacement of the worn mantle supported on the crushing head 18. The lowermost portion of the mounting edge 32 formed on the main shaft 12 includes an attachment surface that received a seal ring assembly 40. The seal ring assembly 40 provides a live seal between the mounting edge 32 of the main shaft 12 and the stationary dust collar 36 during the rotational and gyratory movement of the main shaft 12 during operation of the gyratory crusher. As will be described in greater detail below, during the installation of the main shaft 12 into the lower frame 14 of the gyratory crusher 10, the stationary dust collar 36 must be aligned properly such that the dust collar 36 is received within the annular channel 34. During this installation, a seal ring of the seal ring assembly 40 contacts the radial outer surface of the dust collar 36. The details of the seal ring assembly 40 of the present disclosure and the installation process will be described in greater detail below.

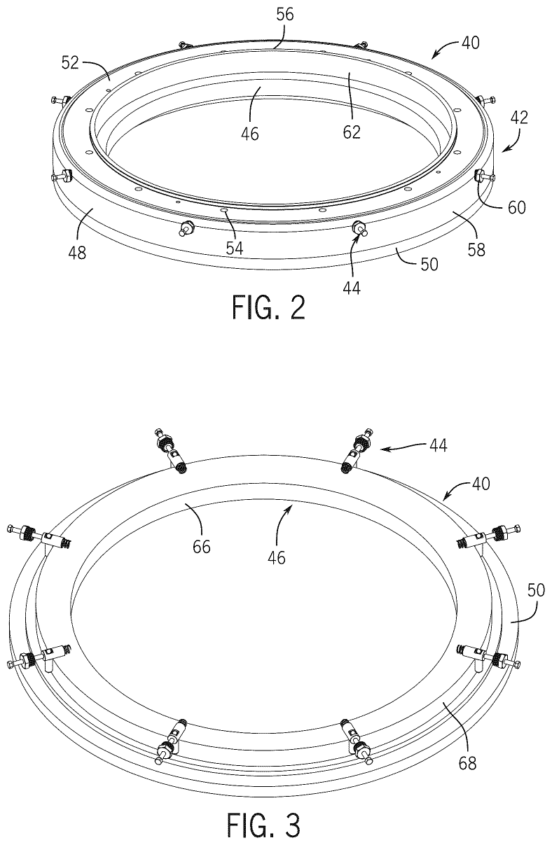

Referring now to FIG. 2, the seal ring assembly 40 is shown removed from the gyratory crusher. The seal ring assembly 40 is shown in an assembled condition and generally includes a retaining ring assembly 42, a plurality of seal ring retention assemblies 44 and a seal ring 46. The entire seal ring assembly 40 is designed to be mounted to the main shaft as a single unit.

As shown in FIG. 2, the retaining ring assembly 42 includes an upper retaining ring 48 and a lower retaining ring 50 that are securely joined to each other to entrap the seal ring 46 between the upper and lower retaining rings 48. The upper retaining ring 48 includes a top attachment surface 52 that includes a series of openings 54 that are designed to allow the entire seal ring assembly 40 to be mounted securely to the lower edge of the mounting edge 32 formed on the main shaft 12 shown in FIG. 1. In other embodiments, the upper retaining ring 48 could be formed as an integral part of the main shaft 12 and would not be a separate component as shown in FIG. 2. Referring back to FIG. 2, at the inner edge of the attachment surface 52 is a lip 56 that aids in restricting the radial movement of the entire seal ring assembly 40 when installed on the main shaft. The outer edge surface 58 of the upper retaining ring 48 includes a series of openings 60 that are each designed to provide access to one of the seal ring retention assemblies 44. Each of the openings 60 extends partially through the radial width of the upper retaining ring 48 but does not open into the inner surface 62, as will be described below and as is shown in other figures.

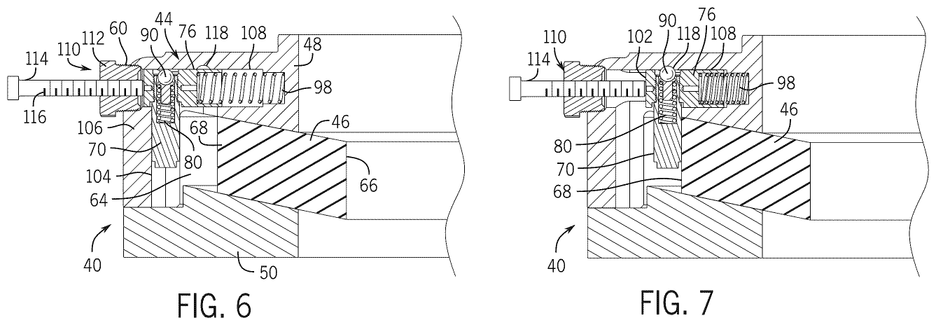

As can be seen in FIGS. 6 and 7, the lower retaining ring 50 and the upper retaining ring 48 are designed to create a seal ring channel 64. The seal ring channel 64 is open to the radial interior of the seal ring assembly 40 and is closed at a radially outward end. The seal ring channel 64 is sized to receive the seal ring 46 such that the seal ring can move radially into and out of the seal ring channel 64. The seal ring channel 64 is angled slightly downward to urge the seal ring 46 toward the center of the seal ring assembly 40 to promote contact between the seal ring 46 and the dust collar. The seal ring 46 is designed as an annular ring that is formed from a durable rubber material and includes an inner contact surface 66 and an outer surface 68.

FIG. 3 illustrates the seal ring assembly 40 with the upper retaining ring 48 removed and only the lower retaining ring 50 illustrated. As shown in FIG. 3, the plurality of seal ring retention assemblies 44 are equally spaced around the outer circumference of the seal ring 46 such that each of the seal ring retention assemblies 48 contact and engage the outer surface 68 of the seal ring 46. The plurality of seal ring retention assemblies 44 are designed to center the seal ring 46 relative to the entire seal ring assembly 40, as illustrated in FIGS. 2 and 3. The centering of the seal ring 46 through the use of the plurality of seal ring retention assemblies 44 allows the seal ring 46 to be centered during installation of the main shaft and the mounted seal ring assembly 40. In the embodiment shown in FIGS. 2 and 3, eight seal ring retention assemblies 44 are shown equally spaced along the outer circumference of the seal ring 46. However, a fewer or greater number of seal ring retention assemblies 44 could be used. In addition, the seal ring retention assemblies 44 are shown equally spaced but it is contemplated that the spacing between the assemblies 44 could be varied depending on how many retention assemblies are used and how widely the assemblies are spaced. Preferably, the number of seal ring retention assemblies used would be equally spaced around the outer circumference of the seal ring 46 to exert an even holding force on the entirety of the seal ring 46.

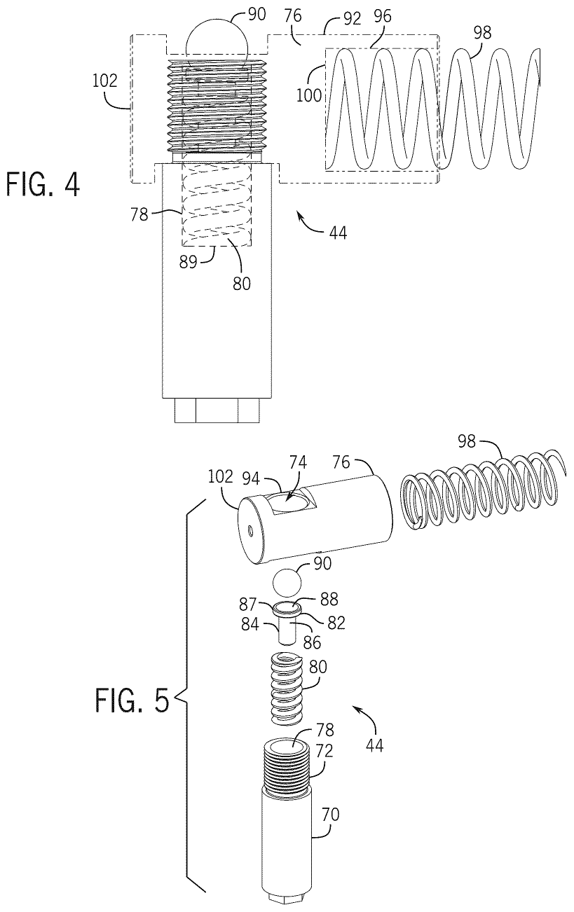

Referring now to FIGS. 4 and 5, the seal retention assembly 44 constructed in accordance with a first embodiment of the present disclosure will now be described. A second embodiment of the seal ring retention assembly will be described in greater detail below. It is contemplated that both the first and second embodiments of the seal ring retention assemblies will perform the same function, namely holding the seal ring in a centered position during installation of the main shaft while allowing the seal ring to move into and out of the sealing channel during operation of the gyratory crusher.

As shown in FIGS. 4 and 5, the seal ring retention assembly 44 includes a lower barrel 70 that includes an upper threaded portion 72 designed to be received within an internally threaded portion 74 of an upper barrel 76. The upper barrel 76 extends perpendicular to the lower barrel 70 in the assembled condition as illustrated. The lower barrel 70 includes an internal spring cavity 78 that is sized to receive a lower end of a spring 80. The upper end of the spring 80 engages a head 82 of a spring bushing 84 that also includes a depending shaft portion 86. The difference in outer diameters of the head 82 and the shaft portion 86 create a contact shoulder 87 that contacts the outer end of the spring 80. In this manner, the spring 80 is entrapped between the bottom wall 89 of the spring cavity 78 and the shoulder 87 in the assembled condition shown in FIG. 4. The head 82 includes a concave ball seat 88 that receives and supports a steel ball 90.

As can be understood in FIGS. 4 and 5, the head 82 contacts an inner edge of the threaded portion 74 to limit the movement of the spring bushing 84. In the biased position shown in FIG. 4, an outer surface of the ball 90 extends past the outer surface 92 of the upper barrel 76. The spring 80 exerts a bias force on the spring bushing 84 to urge the ball 90 into its uppermost biased position shown in FIG. 4. When a downward force is applied on the outer surface of the ball 90, the spring bushing 84 retracts against the bias force of the spring 80 and the ball 90 moves into the opening 94 formed in the upper barrel 76. In this manner, the spring 80 urges the ball 90 outward while a downward force can compress the spring 80 to allow the ball 90 to move into the opening 94.

The upper barrel 76 further includes a spring cavity 96 that is sized to receive another bias spring 98. The inner end of the spring 98 is seated on a back wall 100 such that the spring 98 can be compressed into and out of the spring cavity 96. The upper barrel 76 further includes a back surface 102 that provides a contact surface for moving the upper barrel 76 against the bias force created by the spring 98 in a manner as will be described below.

Referring now to FIGS. 6-9, the operation of one of the plurality of seal ring retention assemblies 44 for holding the seal ring 46 in a centered position will now be described. It should be understood that each of the plurality of seal ring retention assemblies would operate in the same way and in concert with each other to hold the seal ring 46 in a centered position. Referring first to FIG. 6, in this figure, the seal ring retention assembly 44 is shown in its retracted operating position. In this position, the seal ring 46 is free to move into and out of the sealing channel 64 as a result of contact with the dust collar. The retracted operating position shown in FIG. 6 is the normal position of the seal ring retention assembly 44 during operation of the gyratory crusher.

In this retracted operating position, the lower barrel 70 is biased into contact with an outer wall 104 defined by the outer skirt wall 106 of the upper retaining ring 48 by the spring 98. The spring 98 is received within a spring cavity 108 also formed in the upper retaining ring 48. The spring 98 exerts an outward bias force on the upper barrel 76 to hold the lower barrel 70 in the position shown. In this position, the ball 90 is in a slightly retracted position and compresses the spring 80.

When an installer/operator wishes to move the seal ring 46 to a centered position, the installer utilizes an engagement assembly 110 that is mounted in one of the openings 60 formed in the outer skirt wall 106. Each of the engagement assemblies 110 includes a plug 112 and an engagement bolt 114. The engagement bolt 114 includes a threaded outer surface 116 that is received within an internally threaded opening in the plug 112. The end of the engagement bolt 114 contacts the back surface 102 of the upper barrel 76 as illustrated.

When the engagement assembly 110 is positioned as shown, the operator can rotate the engagement bolt 114 in a first direction such that the engagement bolt 114 moves the upper barrel 76 radially inward, as shown in the comparison of FIGS. 6 and 7. The inward movement of the upper barrel 76 further compresses the spring 98, which allows the lower barrel 70 to move into contact with the outer surface 68 of the seal ring 46. The threaded engagement bolt 114 is rotated enough until the ball 90 is received within a recessed detent 118 formed along a top surface of the spring cavity 108. When the ball 90 is aligned with the detent 118, the spring 80 exerts an upward bias force to retain the ball 90 within the detent 118. The location of the lower barrel 70 when the ball 90 is received within the detent 118 defines a centered position for the seal ring 46. The interaction between the ball 90 and the detent 118, as a result of the bias force created by the spring 80, holds the entire seal ring retention assembly 44 in an engaged, centering position. When the seal ring retention assembly 44 is in the engaged centering position, the seal ring 46 is positively held in a centered position as shown in FIG. 7.

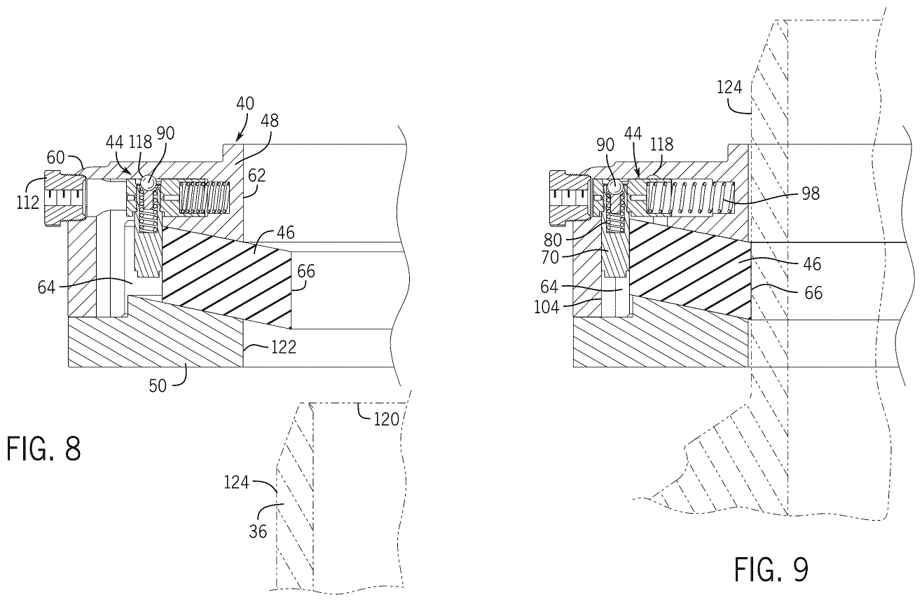

Referring now to FIG. 8, once the seal ring retention assembly 44 is properly positioned such that the ball 90 is received within the detent 118, the engagement bolt 114 can be removed, as can be seen in the comparison of FIGS. 7 and 8. The plug 112 remains in the opening 60 to restrict the access of dirt into the sealing channel 64. When each of the sealing ring assemblies 44 are in the position shown in FIG. 8, the main shaft with the installed seal ring assembly 40 can be installed into the frame of the gyratory crusher. As shown in FIG. 8, the stationary dust collar 36 includes a top end 120 that is designed to be received within the inner diameter defined by the inner surface 62 formed on the upper retaining ring 48 and the inner surface 122 formed on the lower retaining ring 50.

Depending upon the alignment of the main shaft and the dust collar 36 as the main shaft is lowered, the outer surface 124 of the dust collar 36 may contact the contact surface 66 formed on the seal ring 46. This contact will exert an outward force on the seal ring 46 and push the seal ring 46 further into the sealing channel 64. During this movement, the ball 90 will move out of the detent 118 and again compress the spring 80. Once the ball 90 is unseated from the detent 118, the bias force created by the spring 80 will move the sealing ring assembly 44 to the retracted operating position. The movement of the seal ring 46 will thus unseat the ball 90 and the spring 98 will move the lower barrel 70 back into contact with the outer wall 104 as shown in FIG. 9. In the condition shown in FIG. 9, the seal ring retention assembly 44 is retracted. However, depending on the alignment of the main shaft during installation, one or more other seal ring retention assemblies located on the opposite side of the annular seal ring 46 may remain in the engaged centering position. The use of the plurality of seal ring retention assemblies 44 positioned along the entire outer circumference of the seal ring 46, as best shown in FIGS. 2 and 3, allows the seal ring 46 to flex and extend further into or out of the sealing channel 64 during the installation as shown in the images of FIGS. 6-9.

In the embodiment of the seal ring retention assemblies 44 shown in FIGS. 2-9, the seal ring retention assemblies 44 each exert a longitudinal force directed in the radial direction on the seal ring 46 to hold the seal ring 46 in the centered position shown in FIG. 7. When the seal ring 46 is urged radially outward during installation or the operation of the gyratory crusher, the outward radial movement of the seal ring 46 exerts a radially outward force on the seal ring retention assembly to move unseat the ball and allow the spring 98 to move the seal ring retention assembly back to the retracted operating position shown in FIGS. 6 and 9.

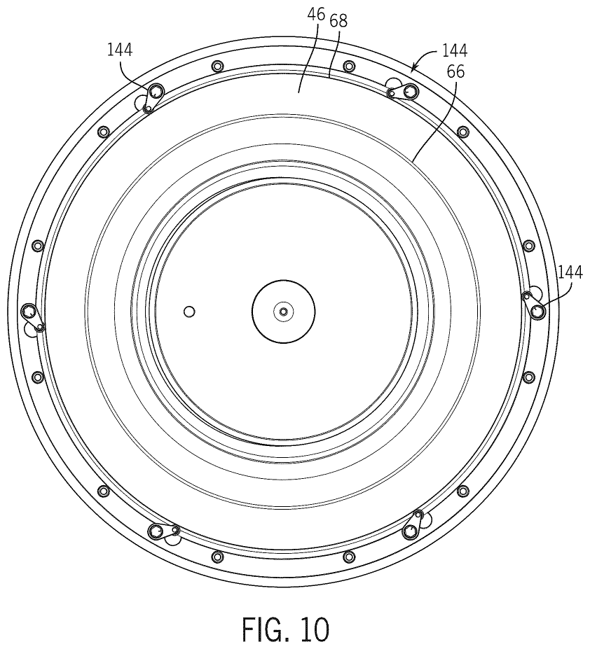

In accordance with the present disclosure, a second embodiment of seal ring retention assemblies is shown in the images of FIGS. 10-21. In the second embodiment shown in these figures, the seal ring retention assemblies again exert a positive bias force on the seal ring to position and hold the seal ring in a centered position. Each of the seal ring retention assemblies of the second embodiment are movable between an engaged centering position and a retracted operating position. The details of the second embodiment of the seal ring retention assemblies will be described below.

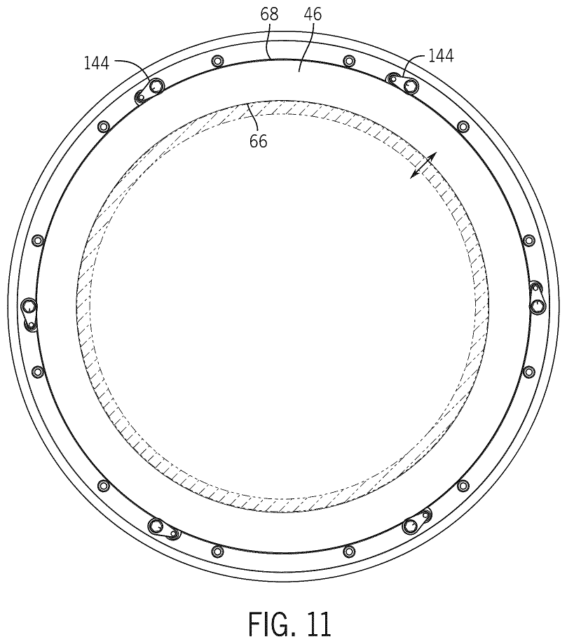

Referring first to FIG. 10, a second embodiment of seal ring retention assemblies are shown by reference numeral 144. The view shown in FIG. 10 is a view of the retention ring assembly similar to the retaining ring assembly 42 shown in FIG. 2. In the embodiment shown in FIG. 10, the lower retaining ring has been removed to more clearly show the series of seal ring retention assemblies 144. As shown in FIG. 10, the seal ring 46 extends between an outer surface 68 and the inner contact surface 66. The seal ring 46 shown in the second embodiment is identical to the seal ring 46 shown in the first embodiment. The second embodiment of the seal ring retention assemblies 144 provide a second type of mechanism to hold the seal ring 46 in a centered position shown in FIG. 10. Like the first embodiment of FIG. 3, in the second embodiment, a plurality of seal ring retention assemblies 48 are spaced along the outer circumference of the seal ring 46 to exert a holding force on the seal ring 46 to hold the seal ring 46 in the centered position. Each of the seal ring retention assemblies 144 are identical. In the embodiment shown in FIG. 10, each of the seal ring retention assemblies are shown in an engaged centering position in which the seal ring retention assemblies 144 each exert a positive force on the outer surface 68 of the seal ring 46 to hold the seal ring 46 in the centered position. FIG. 11 illustrates each of the seal ring retention assemblies 144 in a retracted operating position in which the seal ring 46 is movable radially into and out of the retaining ring assembly either during the installation phase or operational phase of the gyratory crusher.

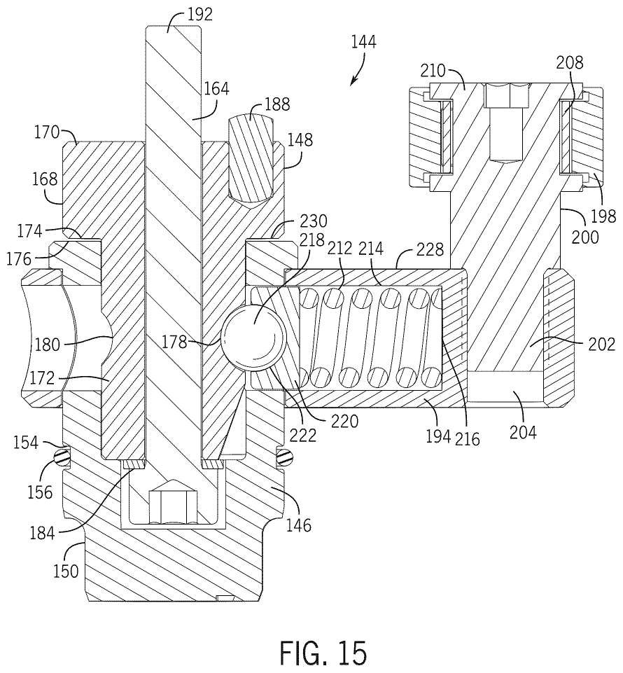

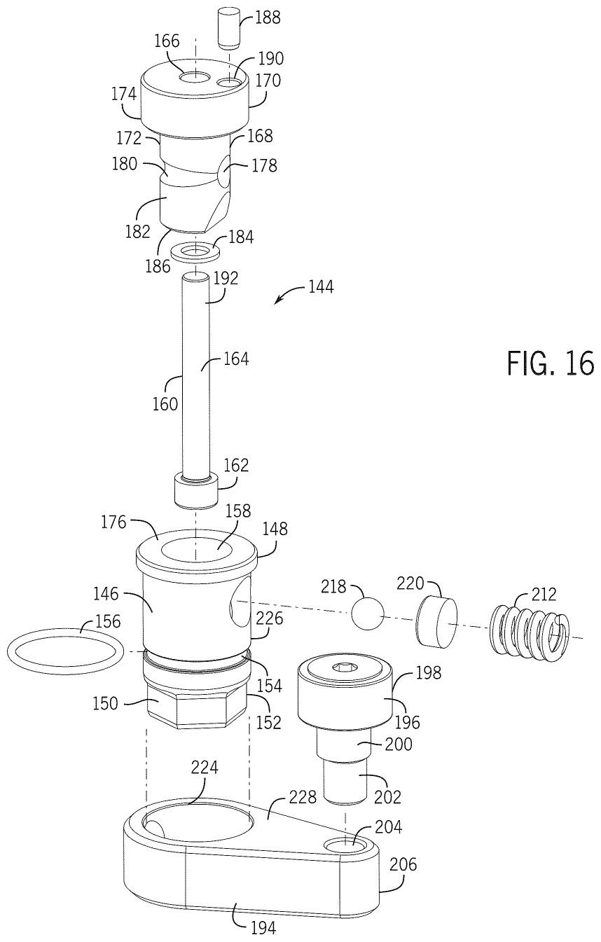

FIG. 15 is a section view and FIG. 16 provides an exploded view of one of the ring retention assemblies 144 constructed in accordance with a second embodiment of the present disclosure. The seal ring retention assembly 144 includes a support body 146 that extends between the upper head portion 148 and includes an adjustment head 150 having a series of flat facets 152 that can be engaged to rotate the entire support body 146. The support body 146 includes an annular groove 154 sized to receive a sealing ring 156. The sealing ring 156 can be a conventional O-ring formed from a flexible rubber material.

The support body 146 includes a center opening 158 that receives a fixing screw 160 having a head 162 and an attachment shaft 164. The attachment shaft 164 is received within an opening 166 that extends through an adjustment plug 168. The adjustment plug 168 includes a head portion 170 that is joined to an adjustment body 172. As illustrated, the outer diameter of the adjustment body 172 is less than the outer diameter of the head portion 170 such that a shoulder 174 is created between the differing diameters. The shoulder 174 contacts an upper surface 176 formed on the support body 146 when the seal ring retention assembly 144 is fully assembled.

The outer surface of the adjustment body 172 includes both a recessed detent 178 and an eccentrical groove 180. The eccentrical groove 180 extends around the outer surface 182 and has a depth that increases from the detent 178. A washer 184 is positioned between the head 162 of the fixing screw 160 and a contact surface 186 such that the head 162 of the fixing screw 160 can rotate relative to the stationary adjustment plug 168. The head portion 170 of the adjustment plug 168 further includes a positioning pin 188 that is received within a pin hole 190. The combination of the upper end 192 on the fixing screw 160 and the positioning pin 188 are used to prevent rotation of the adjustment plug 168 in a manner to be described below.

The seal ring retention assembly 144 of the second embodiment further includes a support arm 194 that is designed to space and support a support roll 196. The support roll 196 includes a support roller 198 that is rotatably supported about a support shaft 200. The support shaft 200 includes a lower hub 202 that is received within an opening 204 formed near the outer end 206 of the support arm 194. As best shown in FIG. 15, the support roller 198 is rotatable about a bearing 208 positioned between the outer end 210 of the shaft 200 and the support roller 198.

As shown in FIGS. 15 and 16, a bias spring 212 is received within a spring cavity 214 formed in the support arm 194. The spring 212 contacts a back wall 216 and exerts an outward bias force on a ball 218 supported by a support bushing 220. The support bushing 220 includes a concave ball seat 222 that provides support for the ball 218. As shown in the assembled condition in FIG. 15, the ball 218 is received within the detent 178 of the adjustment plug 168.

Referring back to FIG. 16, the support arm 194 includes a receiving opening 224 that is sized to receive and engage the outer surface 226 on the support body 146. In the received position shown in the cross-section view of FIG. 15, an engagement surface 228 contacts the shoulder 230 formed on the upper head portion 148. The interaction between the shoulder 230 and the engagement surface 228 holds the support arm 194 in the position shown such that the spring cavity 214 and the ball 218 are aligned with the detent 178. The support arm 194 is designed to be fixed to the support body 146 such that the combination of the two components can rotate about the stationary adjustment plug 168.

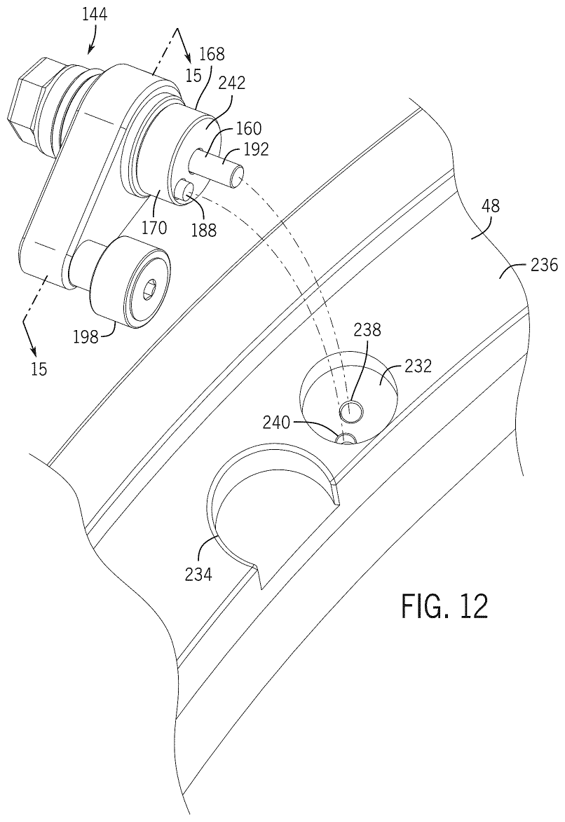

Once the seal ring retention assembly 144 is fully assembled, the seal ring retention assembly 144 can be installed into the upper retaining ring 48 as shown in FIG. 12. In the embodiment shown in FIG. 12, the upper retaining ring 48 is formed as an integral part of the main shaft and is not a separate component as shown and described in FIGS. 2 and 3. As shown in FIG. 12, the upper retaining ring 48 formed as part of the main shaft includes a receiving cavity 232 and an access cavity 234 each recessed from an otherwise flat surface 236. The receiving cavity 232 includes a center hole 238 that is positioned and sized to receive the end 192 of the fixing screw 160. A pin hole 240 is positioned to receive the positioning pin 188 that extends from the outer surface 242 formed on the head portion 170 of the adjustment plug 168. The interaction between the seal ring retention assembly 144 and the pair of the center hole 238 and the pin hole 240 aids in properly locating the adjustment plug 168 and when the adjustment plug 168 is properly positioned, prevents rotational movement of the adjustment plug 168 when the seal ring retention assembly 144 is installed.

When the seal ring retention assembly is installed and in the retracted operating position, the support roller 198 is received within the access cavity 234. The access cavity 234 is sized slightly larger than the support roller 198 to allow free movement of the support roller 198 into and out of the access cavity 234.

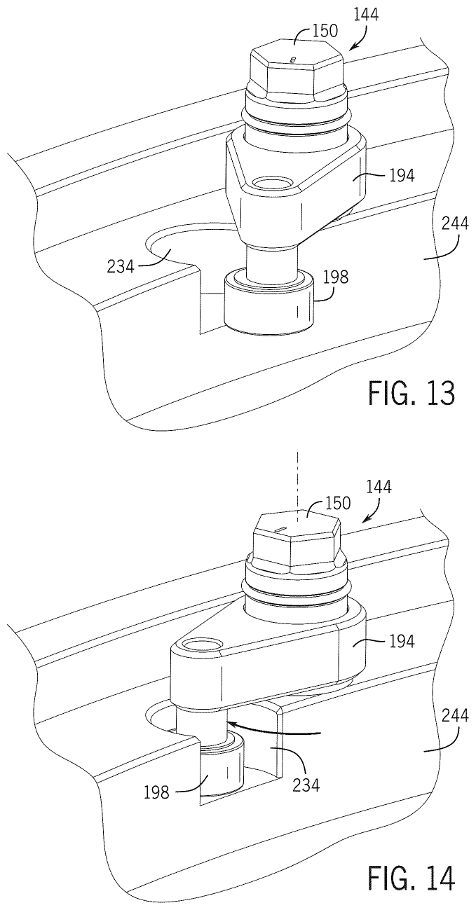

FIGS. 13 and 14 illustrate the movement of the seal ring retention assembly 144 from the engaged centering position shown in FIG. 13 to the retracted operating position of FIG. 14. As discussed previously, when the seal ring retention assembly 144 is in the retracted operating position, the support roller 198 is recessed into the access cavity 234 and is thus radially spaced from the back wall 244. In this retracted position, the seal ring retention assembly 144 does not affect the movement of the seal ring.

When the seal ring retention assembly 144 is in the engaged centering position, the support roller 198 is located outside of the access cavity 234 and extends past the back wall 244. In this engaged centering position, the support roller 198 contacts the outer edge of the seal ring to exert a holding force on the seal ring to hold the seal ring in a centered position.

The seal ring retention assembly 144 can be moved between the engaged centering position of FIG. 13 to the retracted operating position of FIG. 14 by engaging and rotating adjustment head 150. During rotation of the adjustment head 150, the entire support arm 194 rotates along with the rotation of the adjustment head 150, thus causing the support roller 198 to rotate into and out of access cavity 234. In this manner, an operator can manually adjust the position of the support roller 198 to control the support for the seal ring 46.

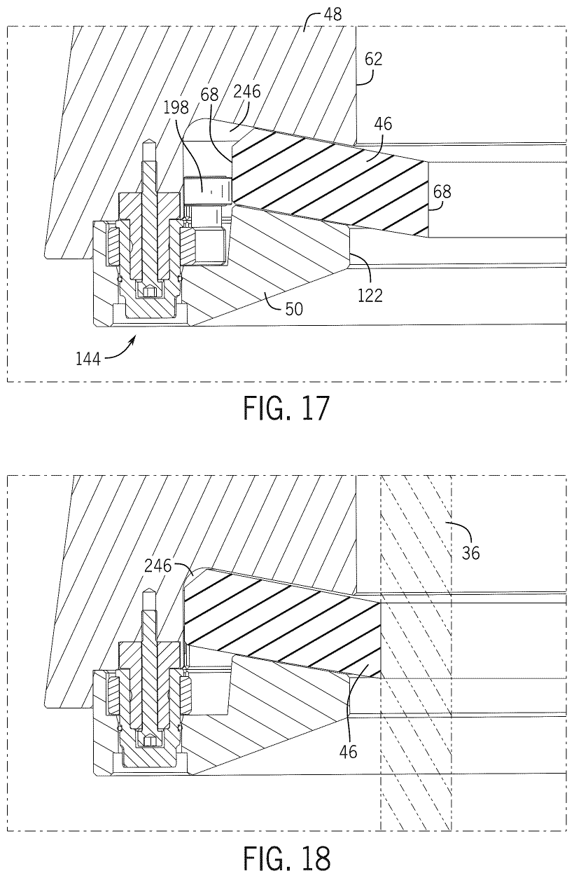

Referring now to FIG. 17, the seal ring retention assembly 144 is shown in the engaged centering position. In this engaged centering position, the support roller 198 contacts the outer surface 68 of the seal ring 46. In this position, the contact surface 68 of the seal ring 46 extends past the inner surface 62 of the upper retaining ring 48 and the inner surface 122 of the lower retaining ring 50. In this position, the ball 218 is received within the detent 178 to pull the support roller 198 in the engaged centering position, as can be best understood in FIG. 15. During the installation of the main shaft, each of the seal ring retention assemblies 144 are moved to this engaged centering position as best illustrated in FIG. 10.

As the main shaft is lowered and the seal ring 46 begins to contact the dust collar 36 as shown in FIG. 18, the seal ring 46 is pressed inward into the sealing channel 246 as can be understood in the comparisons of FIGS. 17 and 18. The radially outward force that causes the seal ring 46 to move radially inward presses the support roller 198 inward from the engaged centering position shown in FIG. 13 to the retracted operating position shown in FIG. 14. During this movement, the ball 218 moves out of the detent 178 formed in the adjustment plug 168 and enters into the eccentric groove 180 as best shown in FIG. 16. Since the depth of the eccentric groove 180 increases around the outer surface of the adjustment plug 168, the support roller 198 is allowed to move to the retracted operating position shown in FIG. 14.

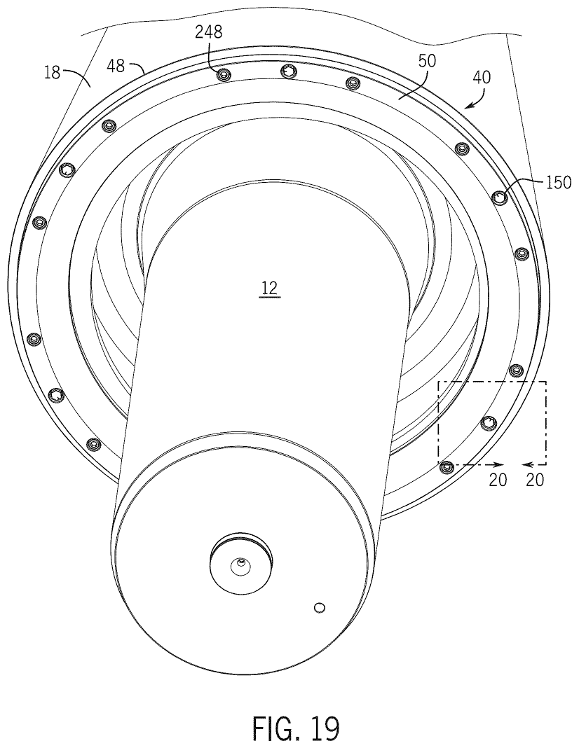

Referring now to FIG. 19, the entire seal ring assembly 40 of the second embodiment is shown mounted to the lower edge of the crushing head 18 of the main shaft 12. In this assembled condition, the lower retaining ring 50 is attached to the upper retaining ring 48 and the crusher head 18 by a series of connectors 248. In this assembled and installed position, the adjustment head 150 of each of the seal ring retention assemblies is accessible from the bottom of the crushing head 18 as shown in FIG. 19.

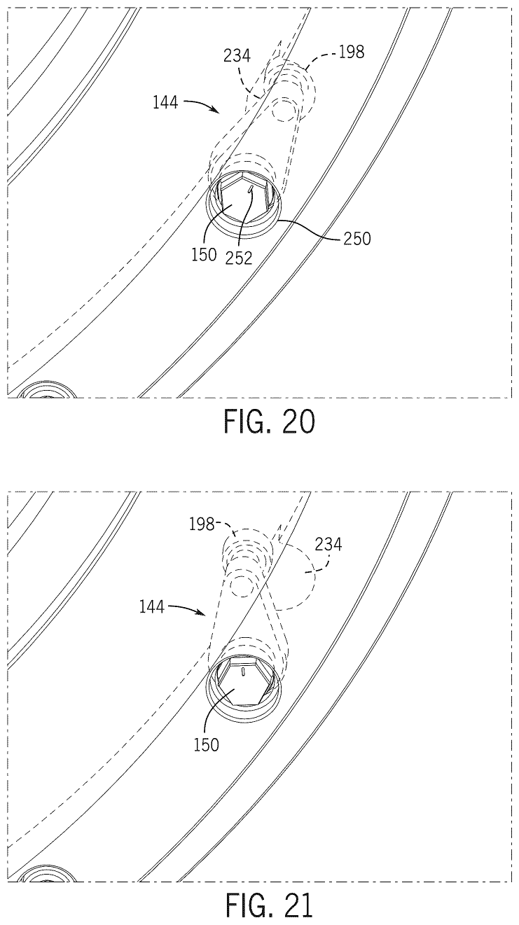

As shown in the magnified view of FIGS. 20 and 21, each of the adjustment heads 150 is recessed within an access opening 250. Enough space is provided between the outer diameter of the access opening 250 and the adjustment head 150 such that a tool, such as a socket wrench, can be inserted and used to rotate the adjustment head 150. In the embodiment shown, the adjustment head 150 includes a visual indicator to indicate the position of the support roller 198. In the embodiment shown, the visual indicator is an alignment dash 252 formed on the outer surface of the adjustment head 150. When the dash 252 is positioned generally perpendicular to the radius of the pressure head, the support roller 198 is recessed into the access cavity 234. When the adjustment head 150 is rotated counterclockwise, the dash 252 is moved indicating that the support roller 198 is moved out of the access cavity 234. In this manner, the user/operator is able to visually determine whether the seal ring retention assembly 144 is in the retracted operating position of FIG. 20 or the engaged centering position of FIG. 21.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A seal ring assembly for use with main shaft and crushing head of a gyratory crusher, comprising:
a retaining ring assembly configured to mount to the crushing head;
a seal ring positioned to extend from the retaining ring assembly; and
a plurality of seal ring retention assemblies that are each positioned to contact the seal ring to hold the seal ring in a centered position.

2. The seal ring assembly of claim 1 wherein each of the plurality of seal ring retention assemblies are positioned in the retaining ring assembly.

3. The seal ring assembly of claim 1 wherein each of the plurality of seal ring retention assemblies is movable between an engaged centering position that holds the seal ring in the centered position and a retracted operating position in which the seal ring is movable within the retaining ring assembly.

4. The seal ring assembly of claim 3 wherein each of the plurality of seal ring retention assemblies is positively retained in the engaged centering position and biased into the retracted operating position.

5. The seal ring assembly of claim 4 wherein each of the plurality of seal ring retention assemblies includes a ball received in a detent to positively retain the seal ring retention assembly in the engaged centering position.

6. The seal ring assembly of claim 3 wherein each of the plurality of seal ring retention assemblies are rotatable between the engaged centering position and the retracted operating position.

7. The seal ring assembly of claim 3 wherein each of the plurality of seal ring retention assemblies are longitudinally movable along a radius of the seal ring between the engaged centering position and the retracted operating position.

8. The seal ring assembly of claim 3 wherein radial movement of the seal ring moves the seal ring retention assemblies from the engaged centering position and the retracted operating position.

9. A seal ring assembly for use with main shaft and crushing head of a gyratory crusher, comprising:
a retaining ring assembly configured to mount to the crushing head, the retaining ring assembly including a seal ring channel;
a seal ring positioned within the seal ring channel and extending from the retaining ring assembly during operation of the gyratory crusher; and
a plurality of seal ring retention assemblies each positioned in the retaining ring assembly and movable between an engaged centering position that holds the seal ring in a centered position and a retracted operating position in which the seal ring is movable within the seal ring channel, wherein each seal ring retention assembly contacts the seal ring to hold the seal ring in the centered position.

10. The seal ring assembly of claim 9 wherein the retaining ring assembly includes an upper retaining ring and a lower retaining ring, wherein the seal ring channel is located between the upper retaining ring and the lower retaining ring.

11. The seal ring assembly of claim 9 wherein each of the plurality of seal ring retention assemblies is positively retained in the engaged centering position and biased into the retracted operating position.

12. The seal ring assembly of claim 11 wherein each of the plurality of seal ring retention assemblies includes a ball received in a detent to positively retain the seal ring retention assembly in the engaged centering position.

13. The seal ring assembly of claim 9 wherein each of the plurality of seal ring retention assemblies are rotatable between the engaged centering position and the retracted operating position.

14. The seal ring assembly of claim 13 wherein each of the plurality of seal ring retention assemblies include a support arm having a support roller that contacts the seal ring in the engaged centering position, wherein the support arm rotates to move the support roller out of contact with the seal ring in the retracted operating position.

15. The seal ring assembly of claim 9 wherein each of the plurality of seal ring retention assemblies are movable longitudinally along a radius of the seal ring between the engaged, centering position and the retracted, operating position.

16. The seal ring assembly of claim 15 wherein each of the plurality of seal ring retention assemblies includes a spring to bias the seal ring retention assembly toward the retracted operating position.

17. The seal ring assembly of claim 9 wherein radial movement of the seal ring moves the seal ring retention assemblies from the engaged centering position and the retracted operating position.

18. A gyratory crusher, comprising:
a main shaft; and
a seal ring assembly mounted to the main shaft, comprising:
a retaining ring assembly mounted to the crushing head, the retaining ring assembly including a seal ring;
a seal ring positioned within the seal ring channel and extending from the retaining ring assembly during operation of the gyratory crusher; and
a plurality of seal ring retention assemblies each positioned in the retaining ring assembly and movable between an engaged centering position that holds the seal ring in a centered position and a retracted operating position out of contact with the seal ring such that the seal ring is movable within the seal ring channel, wherein each seal ring retention assembly contacts the seal ring to hold the seal ring in the centered position.

19. The gyratory crusher of claim 18 wherein each of the seal ring retention assemblies are selectively movable into the engaged centering position to hold the seal ring in the centered position and are moved by the seal ring to the retracted operating position.

20. The gyratory crusher of claim 19 wherein each of the seal ring retention assemblies are positively retained in the engaged centering position and are biased to move into the retraced operating position by a bias spring.
